(19) United States
(12) Patent Application Publication
(10) Pub. No.: US 2021/0049680 A1
(43) Pub. Date: Feb. 18, 2021

(54) REVERSE BID AUCTION

(71) Applicant: Eric A. Solis, Palo Alto, CA (US)

(72) Inventor: Eric A. Solis, Palo Alto, CA (US)

(21) Appl. No.: 16/991,552

(22) Filed: Aug. 12, 2020

Related U.S. Application Data
(60) Provisional application No. 62/885,993, filed on Aug. 13, 2019.

(51) Int. Cl. G06Q 30/08; G06Q 40/02; G06Q 30/04; G06Q 20/06; G06Q 20/36; G06Q 20/40; G06Q 20/02; G06Q 20/34; H04L 9/06

(52) U.S. Cl. CPC G06Q 30/08; G06Q 40/02; G06Q 30/04; G06Q 20/0655; G06Q 20/3672; G06Q 20/4037; G06F 3/0484; G06Q 20/409; G06Q 20/34; H04L 9/0637; G06Q 2220/00; H04L 2209/56; G06Q 20/023

(57) ABSTRACT

A method for implementing an electronic auction includes receiving, from a first electronic device, an auction submission including an identification of a desired item and an account identifier corresponding to a buyer account associated with a user of the first device, posting, on a graphical user interface accessible via a web browser or mobile application installed on a second electronic device, an auction entry corresponding to the auction submission, the auction entry including the identification of the desired item and an amount of funds contained in the buyer account, receiving, via the graphical user interface, a request to initiate a sale of the item for the amount of funds contained in the buyer account, the request including an auction entry identifier and an identification of a seller making the request, and, in response to receiving the request, crediting the amount of funds to a seller account associated with the seller.

### CROSS-REFERENCE TO RELATED APPLICATIONS

The present application claims priority to U.S. Provisional Patent Application Ser. No. 62/885,993 entitled REVERSE BID AUCTION filed Aug. 13, 2019, the disclosure of which is incorporated herein by reference.

### STATEMENT RE: FEDERALLY SPONSORED RESEARCH/DEVELOPMENT

Not Applicable

### BACKGROUND

### 1. Technical Field

The present disclosure relates generally to electronic currency transactions and, more particularly, to electronic auctions for the sale of goods and services.

### 2. Related Art

Software platforms for implementing electronic auctions have limited capability when it comes to supporting auction types beyond conventional forward auctions that are known to be disadvantageous to buyers. For example, eBay.com lists each item for sale in correspondence with a specific seller of the item. With such a system, a buyer's ability to take advantage of seller competition is limited to browsing different listings with potentially different item specifications and quality. While there have been efforts to devise software for more exotic auction types, such as the system described in U.S. Patent Application Pub. No. 2015/0142597 and entitled “REVERSE DUTCH AUCTION PROCESSING METHOD EXECUTED BY A COMPUTER SERVER AND COMPUTER PROGRAMS THEREOF,” such systems fail to provide any mechanism to account for changes over time in the buyer's own ability and willingness to pay, especially in the case of large purchases that a buyer may need to save up for.

### BRIEF SUMMARY

The present disclosure contemplates various systems, methods, and apparatuses for overcoming the above drawbacks accompanying the related art. One aspect of the embodiments of the present disclosure is a non-transitory program storage medium on which are stored instructions executable by a processor or programmable circuit to perform operations for implementing an electronic auction. The operations may include receiving, from a first electronic device, an auction submission including an identification of a desired item and an account identifier corresponding to a buyer account associated with a user of the first electronic device. The operations may include posting, on a graphical user interface accessible via a web browser or mobile application installed on a second electronic device, an auction entry corresponding to the auction submission, the auction entry including the identification of the desired item and an amount of funds contained in the buyer account. The operations may include receiving, via the graphical user interface, a request to initiate a sale of the item for the amount of funds contained in the buyer account, the request including an auction entry identifier and an identification of a seller making the request, and, in response to receiving the request, crediting the amount of funds contained in the buyer account to a seller account associated with the seller.

The operations may include updating the auction entry in response to a change in the amount of funds contained in the buyer account.

The operations may include generating a cryptocurrency payment invoice in response to receiving the auction submission, wherein the posting of the auction entry is performed in response to payment of the cryptocurrency payment invoice.

Another aspect of the embodiments of the present disclosure is a method for implementing an electronic auction. The method may include receiving, from a first electronic device, an auction submission including an identification of a desired item and an account identifier corresponding to a buyer account associated with a user of the first electronic device. The method may include posting, on a graphical user interface accessible via a web browser or mobile application installed on a second electronic device, an auction entry corresponding to the auction submission, the auction entry including the identification of the desired item and an amount of funds contained in the buyer account. The method may include receiving, via the graphical user interface, a request to initiate a sale of the item for the amount of funds contained in the buyer account, the request including an auction entry identifier and an identification of a seller making the request, and, in response to receiving the request, crediting the amount of funds contained in the buyer account to a seller account associated with the seller.

Another aspect of the embodiments of the present disclosure is a system for implementing an electronic auction. The system may include a first electronic device that transmits an auction submission including an identification of a desired item and an account identifier corresponding to a buyer account associated with a user of the first electronic device. The system may include one or more servers that receive the auction submission and post, on a graphical user interface accessible via a web browser or mobile application installed on a second electronic device, an auction entry corresponding to the auction submission, the auction entry including the identification of the desired item and an amount of funds contained in the buyer account. The system may include a second electronic device that transmits, via the graphical user interface, a request to initiate a sale of the item for the amount of funds contained in the buyer account, the request including an auction entry identifier and an identification of a seller making the request. The one or more servers may receive the request and, in response to receiving the request, credit the amount of funds contained in the buyer account to a seller account associated with the seller.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 shows an example electronic auction apparatus according to an embodiment of the present disclosure;

FIG. 2 shows an example data structure for managing auction entries posted by the electronic auction apparatus; and

FIG. 3 shows an example of a computer in which the electronic auction apparatus of FIG. 1, operational flows associated therewith, and/or other embodiments of the disclosure may be wholly or partly embodied.

### DETAILED DESCRIPTION

The present disclosure encompasses various embodiments of systems, methods, and apparatuses for implementing an electronic auction. The detailed description set forth below in connection with the appended drawings is intended as a description of several currently contemplated embodiments and is not intended to represent the only form in which the disclosed invention may be developed or utilized. The description sets forth the functions and features in connection with the illustrated embodiments. It is to be understood, however, that the same or equivalent functions may be accomplished by different embodiments that are also intended to be encompassed within the scope of the present disclosure. It is further understood that the use of relational terms such as first and second and the like are used solely to distinguish one from another entity without necessarily requiring or implying any actual such relationship or order between such entities.

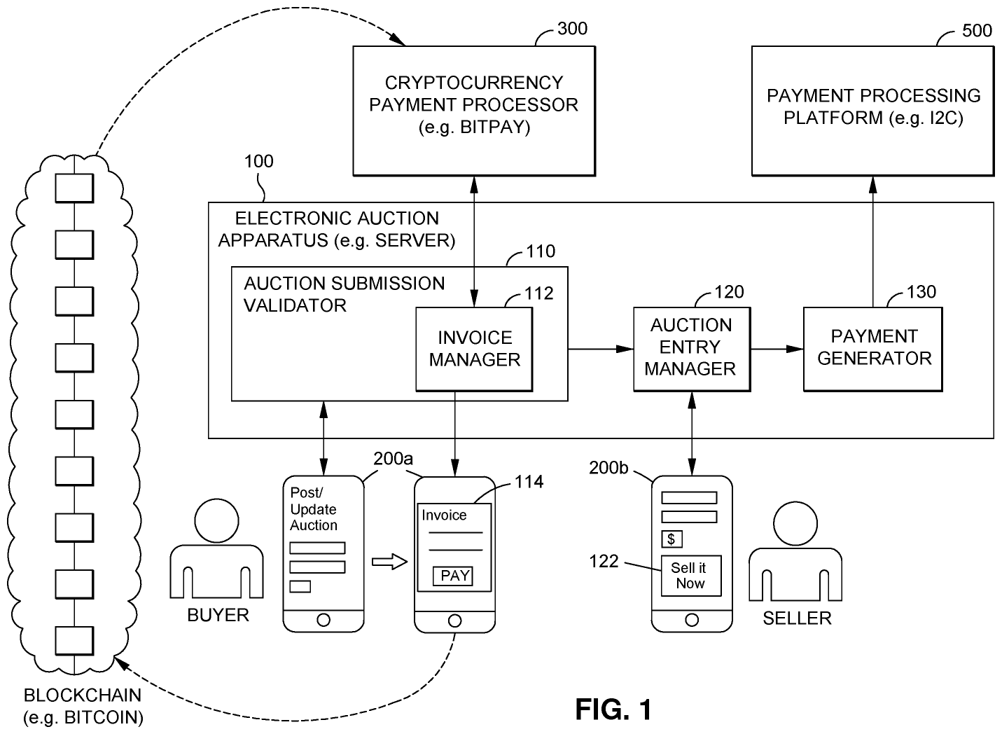

FIG. 1 shows an example electronic auction apparatus 100 according to an embodiment of the present disclosure. The electronic auction apparatus 100 may be a server or a combination of networked servers that interacts with a web browser or mobile application of one or more user devices 200a, 200b (e.g. mobile devices), a cryptocurrency payment processor 300 such as BitPay, and/or a payment processing platform 500 such as the Agile Payments processing platform by i2C Inc. In the example of FIG. 1, a first user of the electronic auction apparatus 100, a “buyer,” would like to set aside funds to buy a specified item of goods or services now or in the future, such as a car, boat, jewelry, vacation, etc. For example, the buyer may wish to buy a flat screen TV of a particular model or having particular specifications or meeting a range of specifications. The buyer may only have limited funds at the moment and may wish to save up for the TV. Rather than merely setting aside funds to accumulate, e.g. in a savings account, the buyer may access a graphical user interface on the device 200a to submit an auction request linked to a buyer account containing the funds. The electronic auction apparatus 100 may then post an auction entry on a graphical user interface accessible to a device 200b belonging to a second user of the electronic auction apparatus 100, a “seller.” As the buyer's ability and willingness to pay for the flat screen TV changes, the buyer may add funds to the buyer account or, in some cases, pull funds from the buyer account, and the electronic auction apparatus 100 may update the auction entry accordingly. At any time when a seller is willing to sell the item for the amount of funds in the buyer account, the seller may initiate the sale over the graphical user interface on the device 200b, e.g. by pressing a “SELL IT NOW” button 122. In response, the electronic auction apparatus 100 may then credit the amount of funds contained in the buyer account to a seller account associated with the seller.

By virtue of the electronic auction apparatus 100, the buyer is able to purchase the TV or other item at a relatively low price as multiple sellers must compete to initiate the sale. At the same time, the buyer is able to freely update the buying price directly according to her own ability and willingness to pay as determined by the amount of funds set aside for the item in the buyer's account. Moreover, because the time spent accumulating funds to save up for the item runs concurrently with the time allotted for sellers to compete to sell the item, the electronic auction apparatus 100 may effectively leverage the buyer's own uncertainty and hesitation to reduce the price of the item. For example, if a buyer perceives that the cost of the flat screen TV is $500 but only has $300 available to spend on it and can only set aside another $50 every month, the buyer might ordinarily set aside funds in an account and then shop for the TV at the end of four months (i.e. once the total is $500). By posting an auction entry corresponding to the buyer's auction submission including an account identifier corresponding to the account containing the funds, the electronic auction apparatus 100 may allow the buyer to adhere to the same savings schedule while all the while sellers are competing to make the sale. As such, the buyer may be pleasantly surprised to find, for example, that the sale was made at $400 after just two months. In a case where the buyer account is funded by a loan from a bank or other financial institution, the consumer's debt may effectively be reduced by $100.

The electronic auction apparatus 100 may include an auction submission validator 110, an auction entry manager 120, and a payment generator 130. The auction submission validator 110 may receive, from a first electronic device 200a, an auction submission including an identification of a desired item and an account identifier corresponding to a buyer account associated with a user of the first electronic device 200a. The buyer account may be a virtual currency account and may be held by the provider of the electronic auction apparatus 100. In some cases, the buyer account may be a pre-existing account designated by the buyer using the first electronic device 200a. In other cases, the account identifier may identify a new account that is not in existence prior to the auction submission. In such case, the account identifier may be a placeholder identifier corresponding to a yet-to-be opened new buyer account, and the electronic auction apparatus 100 may open up the new buyer account in response to receipt of the auction submission. The auction submission may be generated by user interaction with a graphical user interface (GUI) accessible on a website or mobile application of the provider of the electronic auction apparatus 100. Such a GUI (e.g. “Post/Update Auction” in FIG. 1) may include, for example, one or more fields for identifying the specific item of interest (e.g. a specific product model) or the specific attributes of a non-specific item, one or more fields for identifying a pre-existing account or for opening a new account to serve as the buyer account for the auction submission, and, in the case of a new account, one or more fields identifying a funding source and amount for the new account. The GUI may further include one or more additional fields for identifying the buyer in a case that the buyer is a new user and thus not already identified by virtue of having logged in to the GUI.

Upon receipt of the auction submission, the auction submission validator 110 may validate one or more aspects of the received auction submission. For example, in the case of an account identifier corresponding to a buyer account to be newly created, the auction submission validator 110 may check the availability of funds in the funding source against the amount to be funded. In a case where a funding source is a virtual currency account held by the provider of the electronic auction apparatus 100, such validation may include checking a balance of the funding account and transferring the amount of the auction submission to the new buyer account to be created. If the balance of the funding account is insufficient, the electronic auction apparatus 100 may display an error message to the buyer on the GUI. The funding source may also be an incoming payment from an outside account not held by the provider of the electronic auction apparatus 100, in which case the auction submission validator 110 may validate a credit card transaction, automated clearing house transaction, etc.

As a specific example, the electronic auction apparatus 100 may support cryptocurrency payments, in which case the auction submission validator 110 may include an invoice manager 112 that generates a cryptocurrency payment invoice 114 on the GUI as shown in FIG. 1. The invoice manager 112 may communicate with a cryptocurrency payment processor 300 such as BitPay to generate the cryptocurrency payment invoice 114, for example, by calling an API associated with the cryptocurrency payment processor 300. The payment address of the cryptocurrency payment invoice 114 may be a cryptocurrency account associated with the provider of the electronic auction apparatus 100. The cryptocurrency payment invoice 114 may then be presented to the buyer on the GUI to be accessed by the buyer using the electronic device 200a. The cryptocurrency payment invoice 114 may be, for example, a BitPay invoice and may include, in addition to the payment amount, a QR code encoding the payment address, the payment address itself to be copied and pasted, and/or a link to populate the payment address directly to a cryptocurrency wallet on the same electronic device 200a. After presenting the cryptocurrency payment invoice 114 to the buyer, the invoice manager 112 may await payment of the cryptocurrency payment invoice 114.

The buyer may pay the cryptocurrency payment invoice 114, for example, by authorizing payment using a cryptocurrency wallet on the same electronic device 200a. The payment by the user may then be recorded to a blockchain 400 associated with the cryptocurrency (e.g. a Bitcoin blockchain), for example, by operation of the buyer's cryptocurrency wallet. Once the cryptocurrency payment invoice 114 is paid, for example, as established by a predetermined number of confirmations on the blockchain 400, the electronic auction apparatus 100 or the cryptocurrency payment processor 300 may reflect the “paid” status to the cryptocurrency payment invoice 114, in response to which the invoice manager 112 may update the record of the auction submission to reflect that the cryptocurrency payment invoice 114 has been paid. In response to such update, the auction submission validator 110 may move the funds into the buyer account and complete the validation of the auction submission.

The auction entry manager 120 may post, on a graphical user interface (GUI) accessible via a web browser or mobile application installed on a second electronic device 200b, an auction entry corresponding to the auction submission. The auction entry may include the identification of the desired item and the amount of funds contained in the buyer account. The auction entry may be viewable by many potential sellers of the item, and it is contemplated that the GUI may allow various seller-oriented functionality including, for example, the ability to browse for similar auction entries (e.g. with similar items), bookmark the auction entry for later consideration, and/or set up a watch on an auction entry so as to be notified (e.g. by email, instant message, text message, voice message, etc.) when the amount of funds in the buyer account changes. While the auction entry remains pending, multiple sellers may view the auction entry and compete for the sale. At any time, an interested seller may initiate the sale of the item for the amount in the buyer account over the graphical user interface on the seller's respective device 200b, e.g. by pressing a “SELL IT NOW” button 122.

Upon posting the auction entry, the auction entry manager 120 may associate an auction entry identifier with the posted auction entry. The auction entry manager 120 may store the buyer account information and the status of the auction entry (e.g. “pending,” “closed,” etc.) in association with the auction entry identifier. As explained above, the buyer may wish to put additional money in her buyer account for the item over time (or in some cases pull money out). As the buyer updates the auction by changing the balance of her buyer account using the GUI on the buyer's respective device 200a, the update may be validated by the auction submission validator 110 in the same ways as described above and the auction entry manager may update the auction entry in response to a change in the amount of funds contained in the buyer account (e.g. each time an update is validated by the auction submission validator 110). The auction entry manager 120 may update the stored data associated with the auction entry identifier accordingly.

When a seller initiates a sale, the auction entry manager 120 may receive, via the GUI, a request to initiate the sale of the item for the amount of funds contained in the buyer account. The request may be received in response to user interaction of a seller with the GUI on the device 200b, for example, tapping of a “SELL IT NOW” button 122 on a profile page associated with the item or the buyer. The request may include an auction entry identifier corresponding to the auction entry associated with the request and an identification of the seller making the request (e.g. by virtue of the seller having logged in to the GUI). The auction entry manager 120 may update the data associated with the auction entry identifier to reflect the receipt of the request, for example, to associate the identification of the seller with the auction entry identifier. The auction entry manger 120 may update the auction entry accordingly, for example, by taking down the post or marking the item as no longer available on the GUI.

In response to the auction entry manager 120 receiving the request (e.g. in response to a relevant update to a database entry associated with the auction entry identifier), the payment generator 130 may credit the amount of funds contained in the buyer account to a seller account associated with the seller. For example, with the seller having initiated the sale of the item using the GUI on the device 200b, the payment generator 130 may communicate a payment request including seller account information associated with the seller to a payment processing platform 500 such as the Agile Payments processing platform by i2C Inc. Alternatively, in a case where the seller holds a virtual currency account with the provider of the electronic auction apparatus 100, the payment generator 130 may simply update the buyer and seller accounts to reflect movement of funds from the buyer account to the seller account.

In a case where cryptocurrency payments are supported as described above, the electronic auction apparatus 100 may use the methods described in co-pending U.S. patent application Ser. No. 16/376,450, entitled “BLOCKCHAIN PAYMENT SYSTEM,” the entire disclosure of which is hereby incorporated by reference. In the example shown in FIG. 1, the cryptocurrency payment processor 300 is depicted as a third-party processor and, in particular, BitPay. However, the disclosed subject matter is not intended to be so limited. For example, other third-party processors may be used besides BitPay. Moreover, the cryptocurrency payment processor 300 may not be a third-party processor at all and may itself be part of the electronic auction apparatus 100 and controlled by the same provider entity.

Along the same lines, in the example shown in FIG. 1, the payment processing platform 500 is depicted as a third-party processing platform and, in particular, an i2C processing platform. However, the disclosed subject matter is not intended to be so limited. For example, other third-party processing platforms may be used besides i2C processing platforms. Moreover, the payment processing platform 500 may not be a third-party processing platform at all and may itself be part of the electronic auction apparatus 100 and controlled by the same provider entity.

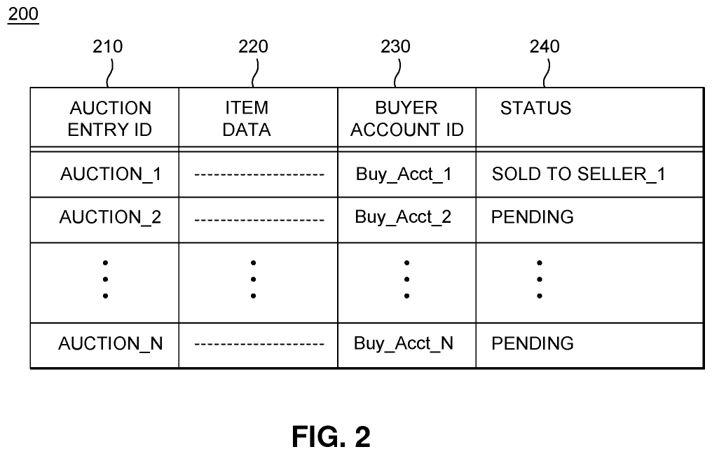

FIG. 2 shows an example data structure 200 for managing auction entries posted by the electronic auction apparatus 100. The data structure 200 may be stored in a database of the electronic auction apparatus 100 and is illustrated in tabular form to represent associations between various items of data as described above in relation to the operations of the auction entry manager 120. For example, a single row of the data structure 200 may correspond to a single auction entry, which may be associated with an auction entry identifier 210, an identification 220 of the desired item (e.g. information to be posted as part of the auction entry as input by the buyer on the electronic device 200a), an account identifier 230 corresponding to the buyer account containing the amount of funds set aside to buy the item, and status information 240 about the auction entry. As shown, the status information 240 may indicate, for example, that the item has been sold to a particular seller and may include a reference to a seller ID (e.g. “SELLER_1”) or a seller account ID for use by the payment generator 130. As another example, the status information 240 may indicate that the auction entry is still pending.

It is contemplated that the disclosed subject matter may include additional features in relation to the following example. A buyer wishing to buy a flat screen TV may take out a loan of $600 but wish to spend less than the full amount of the loan if possible. The electronic auction apparatus 100 (e.g. a GUI thereof) may allow the buyer to place a limit order not to exceed the approved loan of $600 for the flat screen TV, while also putting a lower base amount in the buyer account as described above. The electronic auction apparatus 100 may further allow the buyer to set a regular incremental increase in the amount of the buyer account, e.g. $X per day, funded from a source specified by the buyer. It is further contemplated that a seller may be able to set an asking price, such that the electronic auction apparatus 100 will automatically complete the transaction once the amount in the buyer account reaches the asking price. In some cases, the seller's asking price may be visible to the buyer on the GUI so that the buyer may choose the amount in the buyer account and/or the increment settings with reference to the seller's asking price.

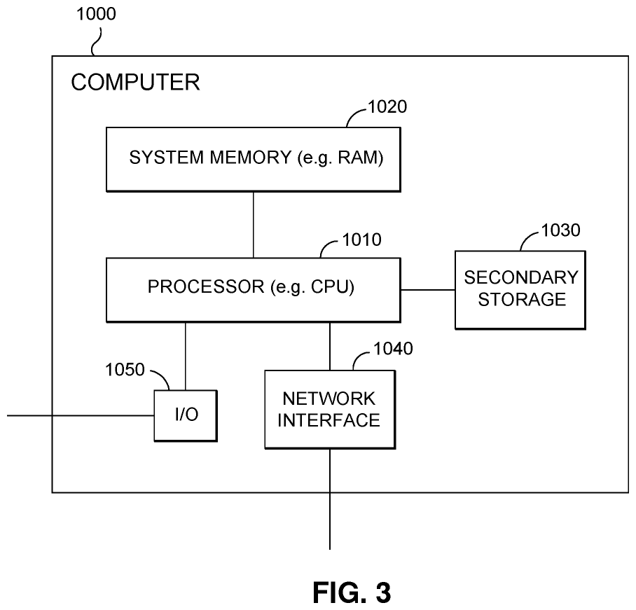

FIG. 3 shows an example of a computer 1000 in which the electronic auction apparatus 100 of FIG. 1 and/or other embodiments of the disclosure may be wholly or partly embodied. As shown in FIG. 3, the computer 1000 may include a processor (e.g. a CPU) 1010, a system memory (e.g. RAM) 1020 that may be connected by a dedicated memory channel to the processor 1010 and temporarily stores results of data processing operations performed by the processor 1010, and a hard drive or other secondary storage device 1030. The processor 1010 may execute one or more computer programs, which may be tangibly embodied along with an operating system in a computer-readable medium, e.g., the secondary storage device 1030. The operating system and computer programs may be loaded from the secondary storage device 1030 into the system memory 1020 to be executed by the processor 1010. The computer 1000 may further include a network interface 1040 for network communication between the computer 1000 and external devices (e.g. over the Internet), such as user devices 200a, 200b accessing the electronic auction apparatus 100 and associated GUIs described throughout this disclosure using a mobile application or web browser, as well as the cryptocurrency payment processor 300 and/or payment processing platform 500. Server-side user interaction with the computer 1000 may be via one or more I/O devices 1050, such as a display, mouse, keyboard, etc.

The computer programs may comprise program instructions which, when executed by the processor 1010, cause the processor 1010 to perform operations in accordance with the various embodiments of the present disclosure. For example, a program that is installed in the computer 1000 may cause the computer 1000 to function as an apparatus such as the electronic auction apparatus 100 of FIG. 1, e.g., causing the computer 1000 to function as some or all of the sections, components, elements, databases, engines, interfaces, modules, managers, validators, generators, etc. of the electronic auction apparatus 100 of FIG. 1 (e.g., the auction submission validator 110, the auction entry manager 120, etc.). A program that is installed in the computer 1000 may also cause the computer 1000 to perform an operational flow, e.g., causing the computer 1000 to perform one or more of the steps described above.

The above-mentioned computer programs may be provided to the secondary storage 1030 by or otherwise reside on an external computer-readable medium such as a DVD-ROM, an optical recording medium such as a CD or Blu-ray Disk, a magneto-optic recording medium such as an MO, a semiconductor memory such as an IC card, a tape medium, a mechanically encoded medium such as a punch card, etc. Other examples of computer-readable media that may store programs in relation to the disclosed embodiments include a RAM or hard disk in a server system connected to a communication network such as a dedicated network or the Internet, with the program being provided to the computer 1000 via the network. Such program storage media may, in some embodiments, be non-transitory, thus excluding transitory signals per se, such as radio waves or other electromagnetic waves. Examples of program instructions stored on a computer-readable medium may include, in addition to code executable by a processor, state information for execution by programmable circuitry such as a field-programmable gate arrays (FPGA) or programmable logic array (PLA).

The above description is given by way of example, and not limitation. Given the above disclosure, one skilled in the art could devise variations that are within the scope and spirit of the invention disclosed herein. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A non-transitory program storage medium on which are stored instructions executable by a processor or programmable circuit to perform operations for implementing an electronic auction, the operations comprising:
receiving, from a first electronic device, an auction submission including an identification of a desired item and an account identifier corresponding to a buyer account associated with a user of the first electronic device;
posting, on a graphical user interface accessible via a web browser or mobile application installed on a second electronic device, an auction entry corresponding to the auction submission, the auction entry including the identification of the desired item and an amount of funds contained in the buyer account;
receiving, via the graphical user interface, a request to initiate a sale of the item for the amount of funds contained in the buyer account, the request including an auction entry identifier and an identification of a seller making the request; and,
in response to receiving the request, crediting the amount of funds contained in the buyer account to a seller account associated with the seller.

2. The non-transitory program storage medium of claim 1, wherein the operations further comprise updating the auction entry in response to a change in the amount of funds contained in the buyer account.

3. The non-transitory program storage medium of claim 2, wherein the operations further comprise issuing a notification to the seller via an electronic communication other than the graphical user interface when the amount of funds contained in the buyer account changes.

4. The non-transitory program storage medium of claim 1, wherein the operations further comprise generating a cryptocurrency payment invoice in response to receiving the auction submission, wherein said posting is performed in response to payment of the cryptocurrency payment invoice.

5. The non-transitory program storage medium of claim 1, wherein the operations further comprise opening up a virtual currency account to serve as the buyer account in response to receiving the auction submission.

6. The non-transitory program storage medium of claim 1, wherein the operations further comprise checking a balance of funds in a funding account designated by the auction submission or validating a credit card or automated clearing house transaction designated by the auction submission.

7. The non-transitory program storage medium of claim 1, wherein the auction submission is generated by user interaction with a graphical user interface accessible on a website or mobile application installed on the first electronic device.

8. The non-transitory program storage medium of claim 1, wherein the identification of the desired item comprises one or more attributes of a non-specific product or service.

9. The non-transitory program storage medium of claim 1, wherein said crediting the amount of funds contained in the buyer account to the seller account includes communicating a payment request to a payment processing platform.

10. A method for implementing an electronic auction, the method comprising:
receiving, from a first electronic device, an auction submission including an identification of a desired item and an account identifier corresponding to a buyer account associated with a user of the first electronic device;
posting, on a graphical user interface accessible via a web browser or mobile application installed on a second electronic device, an auction entry corresponding to the auction submission, the auction entry including the identification of the desired item and an amount of funds contained in the buyer account;
receiving, via the graphical user interface, a request to initiate a sale of the item for the amount of funds contained in the buyer account, the request including an auction entry identifier and an identification of a seller making the request; and,
in response to receiving the request, crediting the amount of funds contained in the buyer account to a seller account associated with the seller.

11. The method of claim 10, further comprising updating the auction entry in response to a change in the amount of funds contained in the buyer account.

12. The method of claim 11, further comprising issuing a notification to the seller via an electronic communication other than the graphical user interface when the amount of funds contained in the buyer account changes.

13. The method of claim 10, further comprising generating a cryptocurrency payment invoice in response to receiving the auction submission, wherein said posting is performed in response to payment of the cryptocurrency payment invoice.

14. The method of claim 10, further comprising opening up a virtual currency account to serve as the buyer account in response to receiving the auction submission.

15. The method of claim 10, further comprising checking a balance of funds in a funding account designated by the auction submission or validating a credit card or automated clearing house transaction designated by the auction submission.

16. The method of claim 10, wherein the auction submission is generated by user interaction with a graphical user interface accessible on a website or mobile application installed on the first electronic device.

17. The method of claim 10, wherein the identification of the desired item comprises one or more attributes of a non-specific product or service.

18. The method of claim 10, wherein said crediting the amount of funds contained in the buyer account to the seller account includes communicating a payment request to a payment processing platform.

19. A system for implementing an electronic auction, the system comprising:
a first electronic device that transmits an auction submission including an identification of a desired item and an account identifier corresponding to a buyer account associated with a user of the first electronic device;
one or more servers that receive the auction submission and post, on a graphical user interface accessible via a web browser or mobile application installed on a second electronic device, an auction entry corresponding to the auction submission, the auction entry including the identification of the desired item and an amount of funds contained in the buyer account; and
a second electronic device that transmits, via the graphical user interface, a request to initiate a sale of the item for the amount of funds contained in the buyer account, the request including an auction entry identifier and an identification of a seller making the request;
wherein the one or more servers receive the request and, in response to receiving the request, credit the amount of funds contained in the buyer account to a seller account associated with the seller.

20. The system of claim 19, wherein the one or more servers generate a cryptocurrency payment invoice in response to receiving the auction submission, said posting being performed in response to payment of the cryptocurrency payment invoice.
